(19) United States
(12) Patent Application Publication
(10) Pub. No.: US 2024/0240366 A1
(43) Pub. Date: Jul. 18, 2024

(54) CARBON FIBER DERIVED FROM PEDOT:PSS FIBER

(71) Applicant: University of Kentucky Research Foundation, Lexington, KY (US)

(72) Inventors: Matthew C. Weisenberger, Lexington, KY (US); Ruben Sarabia-Riquelme, Lexington, KY (US)

(21) Appl. No.: 18/541,729

(22) Filed: Dec. 15, 2023

Related U.S. Application Data
(60) Provisional application No. 63/432,995, filed on Dec. 15, 2022.

(51) Int. Cl. D01F 9/24; C01B 32/205

(52) U.S. Cl. CPC D01F 9/24; C01B 32/205; C01P 2002/82; C01P 2004/03; C01P 2006/40

(57) ABSTRACT

A method of making carbon fibers, includes converting poly (3,4-ethylenedioxythiophene):poly (styrene sulfonate) fibers into the carbon fibers by direct carbonization without previously oxidizing the precursor fibers.

### RELATED APPLICATIONS

This application claims priority to U.S. Provisional Patent Application Ser. No. 63/432,995 filed on Dec. 15, 2022, the full disclosure of which is hereby incorporated by reference.

### TECHNICAL FIELD

This document relates to a method of making carbon fibers by direct carbonization of poly (3,4-ethylenedioxythiophene):poly(styrene sulfonate) fibers (i.e. PEDOT:PSS fibers).

### BACKGROUND

Carbon fibers provide a combination of unique properties that make them particularly suited for applications requiring high strength and lightweight materials. Such applications include, but are not necessarily limited to, aerospace, civil engineering, motor vehicle and sports equipment applications.

Unfortunately, the amount of energy (and thus CO₂ emissions) required to produce 1 kg of carbon fiber by state of the art methods of oxidation and carbonization is immense. Much of this energy stems from the pre-carbonization processing, or oxidation, of the precursor fibers. This is particularly true with respect to the high temperature carbonization processing in large furnaces. Advantageously the method set forth in this document can produce carbon fiber, and by-pass the oxidation step.

More specifically, initial experiments have shown that “direct carbonization” of PEDOT:PSS fiber is possible, and that the resultant carbon fibers are notably pristine, and of quite high tensile strength and modulus. The novel value in protecting this concept stems from the capacity for the PEDOT:PSS fibers to be directly carbonized (no prior oxidation processing necessary). The prospect of new, ‘directly carbonizable’ precursor fibers is important because ‘low energy’ or ‘low carbon dioxide (CO₂)’ carbon fiber will be increasingly important for the environment.

Advantageously, The PEDOT:PSS fiber can be spun, then immediately carbonized—without inter-filament fusion or other problems most precursor fibers present. The present method sheds light towards a path to lower cost carbon fiber, and lower embodied energy in the carbon fiber.

### SUMMARY

In accordance with the purposes and benefits set forth herein, a new and improved method is provided for the direct carbonization of carbon fibers from PEDOT:PSS fibers. The method comprises, consists of or consists essentially of the step of converting poly (3,4-ethylenedioxythiophene):poly (styrene sulfonate) fibers (PEDOT:PSS fibers) into the carbon fibers by direct carbonization without previously oxidizing the PEDOT:PSS fibers.

In at least some of the many possible embodiments of the method, the method includes heating the PEDOT:PSS fibers to a first target temperature of between about 1,0000° C. and about 1,700° C. for a first predetermined period of time sufficient to carbonize the PEDOT:PSS fibers into carbon fibers. Still further, the method may include completing the heating of the PEDOT:PSS fibers in a flowing inert gas (e.g. nitrogen, argon, helium) atmosphere.

In at least some embodiments, the method includes subsequently heating the carbon fibers to a second target temperature of between about 2,000° C. and about 2,800° C. for a second predetermined period of time sufficient to graphitize the carbon fibers. This heating may be completed in a flowing inert gas atmosphere.

In still other possible embodiments, the method includes heating the PEDOT:PSS fibers to a first target temperature of between about 1,1000° C. and about 1,400° C. for a first predetermined period of time sufficient to carbonize the PEDOT:PSS fibers into carbon fibers. This may include completing the heating of the PEDOT:PSS fibers in a flowing inert gas atmosphere.

The method may also include subsequently heating the carbon fibers to a second target temperature of between about 2,200° C. and about 2,600° C. for a second predetermined period of time sufficient to graphitize the carbon fibers. This may include completing the heating of the carbon fibers in a flowing inert gas atmosphere.

In the following description, there are shown and described several different embodiments of the new and improved method for making carbon fibers from PEDOT:PSS fibers by direct carbonization. As it should be realized, the method is capable of other, different embodiments and its several details are capable of modification in various, obvious aspects all without departing from the method as set forth and described in the following claims. Accordingly, the descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the method and together with the description serve to explain certain principles thereof. A person of ordinary skill in the art will readily recognize from the following discussion that alternative embodiments of the method may be employed without departing from the principles described below.

FIGS. 1A-1D are scanning electron microscope (SEM) images of precursor fiber (FIG. 1A), fiber directly carbonized to 1,0000° C. (FIGS. 1B and 1C) and fiber graphitized to 2,7000° C. (FIG. 1D).

FIG. 2 is a graph illustrating tensile strength (MPa) and elastic modulus (GPa) of PEDOT:PSS fibers versus final direct carbonization temperature (° C.). Error bars represent standard deviation between sets of fibers.

FIG. 3A is a graph illustrating electrical conductivity (S/cm) versus final direct carbonization temperature. Error bars represent the standard deviation between sets of fibers.

FIG. 3B is a graph illustrating electrical conductivity (S/cm) versus elastic modulus (GPa) of fibers directly carbonized to 1,0000° C. Error bars represent the standard deviation between sets of fibers.

FIG. 4 is a Raman spectra of PEDOT:PSS fibers directly carbonized to various final temperatures.

FIG. 5A illustrates carbon fiber yield (wt %), tensile strength (MPa) and elastic modulus (GPa) of carbon fibers versus estimated precursor PEDOT concentration (wt %). Error bars represent the standard deviation among a single fiber set.

FIG. 5B illustrates electrical conductivity (S/cm), tensile strength (MPa) and elastic modulus (GPa) of carbon fibers versus their carbon fiber yield (wt %). Error bars represent the standard deviation among a single fiber set.

Reference will now be made in detail to the present preferred embodiments of the method.

### DETAILED DESCRIPTION

In accordance with the method, poly (3,4-ethylenedioxythiophene):poly (styrene sulfonate) fibers (PEDOT:PSS fibers) are converted into the carbon fibers by direct carbonization without previously oxidizing the PEDOT:PSS fibers. “Carbonization” generally refers to heating the PEDOT:PSS fiber precursor in an inert gas (such as nitrogen), to temperatures in the 1000° C. to 20000° C. range. During carbonization, a significant fraction of the precursor is vaporized (typically 20 to 50 wt. % is lost to vapor), and the molecular structure of the precursor is largely converted to carbon (˜95 wt. % carbon). This carbon has crystalline graphitic character, but long-range order to the graphitic crystallites is typically lacking. Typically only is of nm of coherent crystalline dimensions are formed in the carbonization process.

More specifically, the method includes the step of heating the PEDOT:PSS fibers to a first target temperature of between about 1,0000° C. and about 1,700° C. for a first predetermined period of time sufficient to carbonize the PEDOT:PSS fibers into carbon fibers. In one particularly useful embodiment, the method includes heating the PEDOT:PSS fibers to a first target temperature of between about 1,100° C. and about 1,400° C. for a first predetermined period of time sufficient to carbonize the PEDOT:PSS fibers into carbon fibers.

In at least some embodiments, the method then further includes a graphitization step. “Graphitization” generally refers heating a carbonaceous precursor, in an inert gas (e.g. helium), to temperatures in the 2200° to 3000° C. range. During graphitization (of an already carbonized precursor), markedly less mass loss to vapor occurs (compared to carbonization), and the resultant graphitic structure is significantly more ordered with coherent crystalline dimensions in the 10s (sometime 100s) of nm.

More specifically, the method includes subsequently heating the carbon fibers to a second target temperature of between about 2,000° C. and about 2,800° C. for a second predetermined period of time sufficient to graphitize the carbon fibers. In one particularly useful embodiment, the method includes subsequently heating the carbon fibers to a second target temperature of between about 2,200° C. and about 2,600° C. for a second predetermined period of time sufficient to graphitize the carbon fibers. Advantageously the additional graphitization step raises the modulus and conductivity of the resulting carbon fibers.

Any embodiment of the method allows one to spin the PEDOT:PSS fibers and then immediately carbonize them.

### EXPERIMENTAL

### 1.1. Materials and Fiber Processing

PEDOT:PSS water dispersion was obtained from Heraeus (PH1000, 1.3 wt % solid content, 1:2.5 PEDOT:PSS weight ratio [28.57 wt. % PEDOT]). Dimethyl sulfoxide (DSMO), isopropyl alcohol (IPA), and concentrated sulfuric acid (H₂SO₄) were purchased from VWR USA.

The PEDOT:PSS dispersion was concentrated to 2.5 wt % solid content by heating to 100° C. and evaporating water. Then, 5.0 wt % DMSO (relative to the total solution) was added. Using this dope, three types of precursor fibers were fabricated for this work: coagulated, DMSO-drawn, and H₂SO₄-treated fibers. A previously reported procedure for spinning coagulated fibers and DMSO-drawn fibers was employed. In brief, for all fibers, the dope was transferred to a syringe, where it was pumped through a 5 μm nylon filter and extruded from a 100 μm capillary spinneret into a 10 vol % DMSO/IPA coagulation bath. From the coagulation bath, the filament was taken up on a powered roller. For coagulation fibers, the filament was passed through an oven at 170° C. after the first roller and collected on a spool. For DMSO-drawn fibers, the filament was taken from the first roller and drawn through a pure DMSO drawing bath before passing through the oven for drying and collection. For H₂SO₄-treated fibers, the filament was immersed in a pure H₂SO₄ bath after coagulation and then collected directly onto a spool. No oven drying was required. In this study, DMSO-drawn fibers were the typical fiber type which was fabricated and subsequently carbonized. Spooled fibers were extracted intact by sliding off the edge of the take-up cylinder as 2.54 cm diameter hoop tows for carbonization, typically weighing approximately 7 to 9 mg.

Direct carbonization of precursor fibers was performed using a TA Instruments TGA Q500. Fiber hoop tows were hung directly on the Pt hangdown wire with a small Pt weight hung from the bottom of the hoop to both apply tension on the fibers and allow the instrument to properly tare. Fibers were directly carbonized in a nitrogen atmosphere at 10° C./min to various final temperatures up to the TGA's limit of 1000° C. This TGA method allowed for carbonizing small masses of fiber while simultaneously obtaining precise thermogravimetric information. To assess the effect of standard oxidation processing before carbonization, fiber hoop tows were prepared and hung as described previously but were heated in an air atmosphere according to a time-temperature profile with a final temperature of 260° C., similar to that employed for PAN-based fibers.

Graphitization and direct carbonization above 1000° C. were conducted in a Thermal Technology 1000-3060-FP20 graphitization furnace. A 2.54 cm diameter fiber hoop tow was hung inside the furnace with a graphite hanging weight. For graphitization, fibers were first heated to 1300° C. at 10° C./min and then to 2700° C. at 50° C./min in a flowing helium atmosphere.

### 1.2. Characterization

Scanning electron microscope (SEM) imaging was performed on a Hitachi S-4800 field emission SEM at 10-20 kV accelerating voltage and 10 μA beam current. Non-conductive fiber specimens were sputter coated with gold for 110 seconds with a Hummer 6.2 Sputter System prior to imaging. Cross-sections were prepared by razor cutting a fiber bundle while immersed in liquid nitrogen. Fiber cross sectional areas in the resulting SEM micrographs were traced using Adobe Acrobat, from which the fiber's equivalent circular diameter was calculated. The diameter used to calculate the tensile properties and electrical conductivity of a specimen was the average of 20 fibers.

Tensile testing was conducted using the FAVIMAT+ single fiber test system. Precursor fibers were tested at a 25.4 mm gauge length with a pretension of 0.5 cN/tex and 5 mm/min test speed. Carbonized fibers were tested at a 10 mm gauge length with a pretension of 0.5 cN/tex and 0.5 mm/min test speed.

The FAVIMAT+ system was also used to measure the linear density of precursor fibers using an acoustic vibration method to measure the fiber resonance frequency. Given the linear density (LD) of a fiber, the concentration of PEDOT within the fiber (wt. % PEDOT_{fiber}) can be estimated using Equation 1:

$$LD = \frac{{A}_{spinneret} {ρ}_{dope} {C}_{PEDOT : PSS , dope}}{{DR}_{total}} \cdot \frac{wt . \% {PEDOT}_{dope}}{wt . \% {PEDOT}_{fiber}} \qquad Eq . 1$$

where Aₛₚᵢₙₙₑᵣₑₜ is the cross-sectional area of the spinneret orifice, ρ_{dope} is the dope density, C_{PEDOT:PSS, dope} is the concentration of PEDOT:PSS in the dope, DRₜₒₜₐₗ is the total draw ratio, and wt. % PEDOT_{dope} is the weight percentage of PEDOT with respect to PSS in the dope, all of which are known values. Equation 1 is derived from a mass flow balance of PEDOT during wet spinning. With this method, the concentration of PEDOT relative to PSS in a fiber (wt. % PEDOT_{fiber}) spun under certain conditions (i.e., coagulation, DMSO-drawn, sulfuric acid-drawn) was calculated using its linear density as measured by FAVIMAT.

Electrical conductivity was measured using a two-probe method. For each sample, five fibers of different lengths (10, 15, 20, 25, and 30 mm) were contacted to strips of copper tape with silver paint and their resistance was measured with a Keithley 2401 Sourcemeter. Contact resistance, R_{contacts}, was extracted from the resistance versus length plot and was subtracted from the measured fiber resistance, R_{measured}, to calculate the electrical conductivity of a specimen using:

$${σ}_{specimen} = \frac{L}{{R}_{measured} - {R}_{contacts}} \frac{1}{A} \qquad Eq . 2$$

where L is the length of the specimen and A is its cross-sectional area.

Raman spectroscopy was performed using the Renishaw inVia Qontor confocal Raman microscope. Spectra were collected using a 50× objective and 532 nm laser at a laser power of 2.5 mW. Two accumulations of 5s were performed for each fiber specimen with a spectral range from 700 to 2400 cm⁻¹. The integrated intensity of D and G bands for calculation of the I_{D}/I_{G} ratio were determined using Gaussian curve fitting.

Three-dimensional maps of fiber surfaces at the nanoscale were obtained using the Oxford Asylum Cypher S Atomic Force Microscope (AFM) in tapping mode over a window of 0.5 μm×0.5 μm. An Olympus silicon probe with a spring constant of 26 N/m was used.

### 2. RESULTS AND DISCUSSION

### 2.1. Carbon Fiber Morphology and Yield

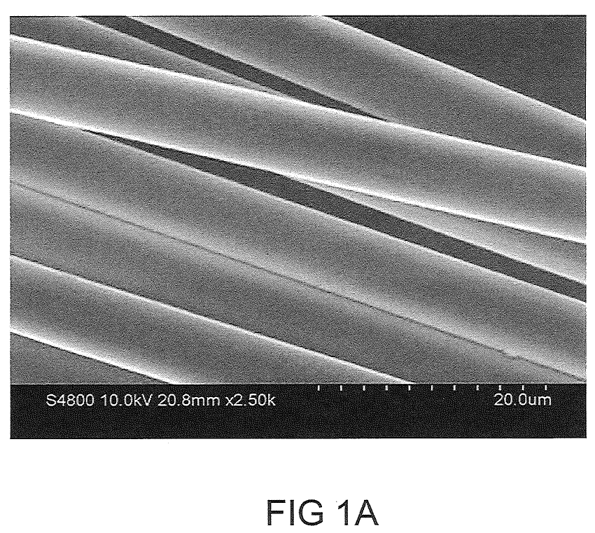

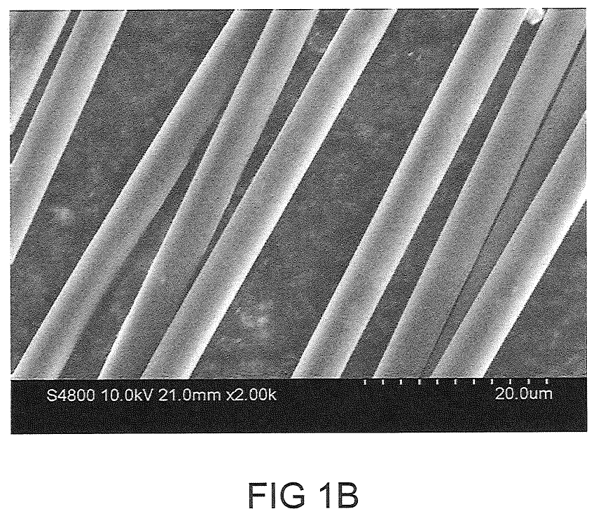

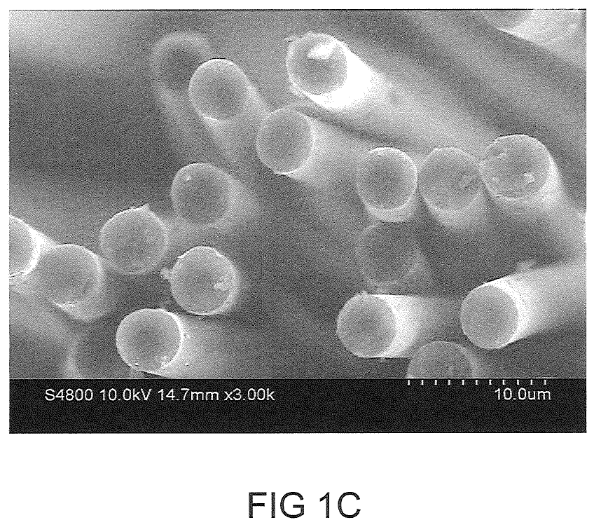

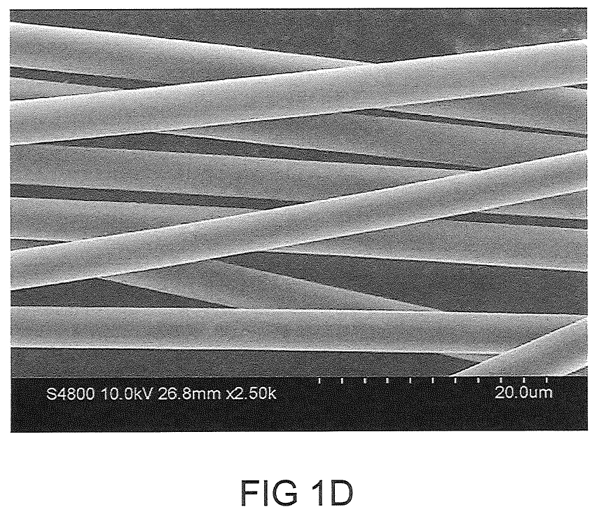

As shown in FIG. 1A, as-spun PEDOT:PSS fibers possessed smooth, defect-free surfaces and had an average diameter of 6.7±0.7 μm. In all cases, direct carbonization and graphitization of precursor fibers produced non-fused CFs also with smooth surfaces free of large defects (FIG. 1B-1D). The average diameter of directly carbonized fibers derived from DMSO-drawn precursor fiber was 4.9±0.3 μm and that of graphitized fibers was 3.7±0.1 μm. The typical CF yield of fibers directly carbonized to 1000° C. was 30-40 wt % (Table 1). Fiber yield stabilized at approximately 30 wt % with further carbonization up to 2700° C. Despite experiencing up to a 75% reduction in cross-sectional area and a 70% mass loss, as was the case after graphitization, no interior voids or surface pitting were observed in any fibers (FIG. 1D). In fact, directly carbonized fibers possessed a surface roughness comparable to that of their precursor (FIG. 1A-1B). 3D AFM maps (not shown) of fiber surfaces show both precursor and graphitized fibers possessed surface roughness on the order of tens of nanometers. Also visible is the preferred orientation along the fiber axis.

TABLE 1
Summary of average fiber properties. The standard deviation
provided is that between unique sets of fibers.

| | | Carbon | Tensile | Elastic | Strain to | Electrical | |
|---|---|---|---|---|---|---|---|
| | Diameter | fiber yield | strength | modulus | failure | conductivity | Raman |
| Fiber | (μm) | (wt %) | (MPa) | (GPa) | (%) | (S/cm) | I_{D}/I_{G} |
| Precursor | 6.7 ± 0.7 | — | 330 ± 60 | 11 ± 2 | 9.1 ± 1.7 | 1810 ± 270 | — |
| Directly | 4.9 ± 0.3 | 38.9 ± 1.8 | 1460 ± 330 | 74 ± 4 | 2.1 ± 0.4 | 200 ± 30 | 0.95 |
| carbonized | | | | | | | |
| Stabilized and | 5.2 ± 0.2 | 31.0 ± 3.7 | 1170 ± 380 | 60 ± 7 | 2.1 ± 0.5 | 150 ± 20 | 0.98 |
| carbonized | | | | | | | |
| Directly | 3.6 ± 0.1 | 29.4 | 930 ± 400 | 220 ± 17 | 0.4 ± 0.2 | 1030 ± 80 | 0.33 |
| graphitized | | | | | | | |

### 2.2. Carbon Fiber Tensile Properties

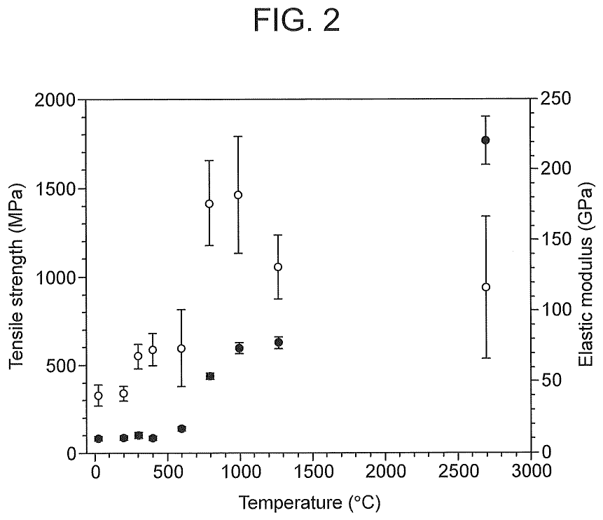

Upon direct carbonization to 1000° C., CFs derived from DMSO-drawn PEDOT:PSS precursor fibers exhibited a tensile strength of 1460±330 MPa, an apparent elastic modulus of 74±4 GPa, and an apparent strain-to-failure of 2.1±0.4%. FIG. 2 displays the effect of final direct carbonization temperature on resultant CF tensile strength and modulus. The maximum tensile strength of CFs was observed after direct carbonization to 1000° C. The highest elastic modulus of 220±17 GPa was observed after graphitization to 2700° C. Both tensile strength and modulus saw significant increases upon carbonization to 800° C., suggesting that the conversion of PEDOT:PSS to a carbon structure commenced between 600° C. and 800° C.

### 2.3. Carbon Fiber Electrical Properties

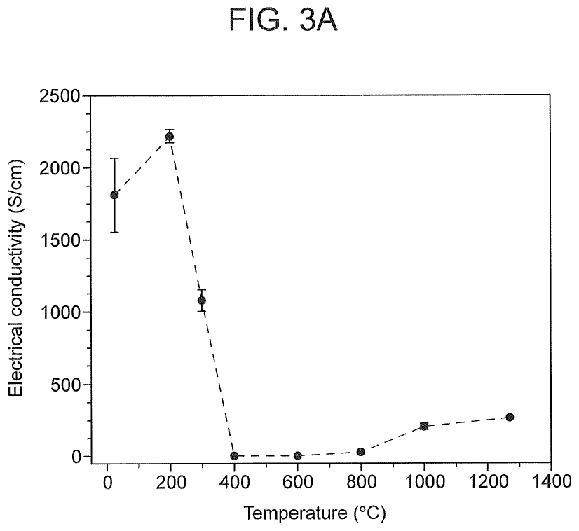

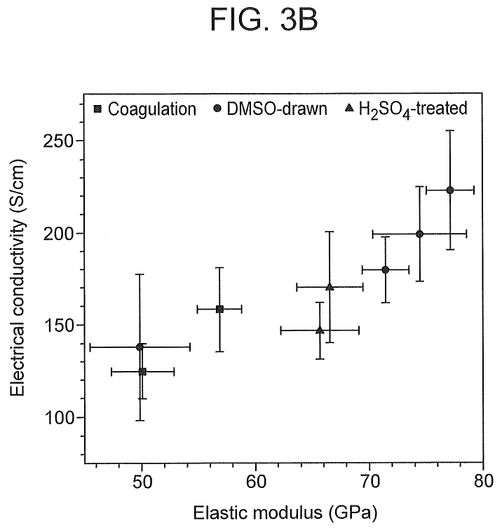

The electrical conductivity of the DMSO-drawn precursor PEDOT:PSS fibers was 1812±256 S/cm. However, resultant fibers directly carbonized to 1000° C. possessed a significantly lower conductivity of 200.0±21.6 S/cm. The electrical conductivity of directly carbonized PEDOT:PSS fibers is plotted with respect to final temperature in FIG. 3A. Upon heating to 200° C., the conductivity of fibers slightly increased. Here, between 200 and 400° C., fiber conductivity rapidly dropped to zero, which suggested the loss of (polaron and bipolaron) charge carriers in the fiber. The conductivity drop corresponded with the greatest fiber mass loss during carbonization. It is unclear what specific chemical changes occur, but the data suggest the material decomposition and associated chemical transformations in this temperature regime serve to destroy the conductive pathways of PEDOT:PSS. After direct carbonization above 800° C., conductivity slowly increased with increasing final temperature. It is believed that the slight recovery of conductivity observed here corresponds with the formation of the graphitic CF structure, where charge carriers are assumed to be electrons.

The electrical conductivity versus elastic modulus of directly carbonized fibers is plotted in FIG. 3B. CFs with a higher elastic modulus tended to be more conductive. This relationship between conductivity and modulus has also been reported for PEDOT:PSS precursor fibers and was attributed to greater orientation of the PEDOT crystalline phase along the fiber axis. Similarly, it is believed that PEDOT:PSS-derived CFs exhibiting higher elastic modulus and electrical conductivity possess a greater degree of orientation of their graphitic planes in the fiber axis direction. Such orientation was observed with AFM at fiber surfaces.

### 2.4. Evolution of Chemical Structure During Carbonization

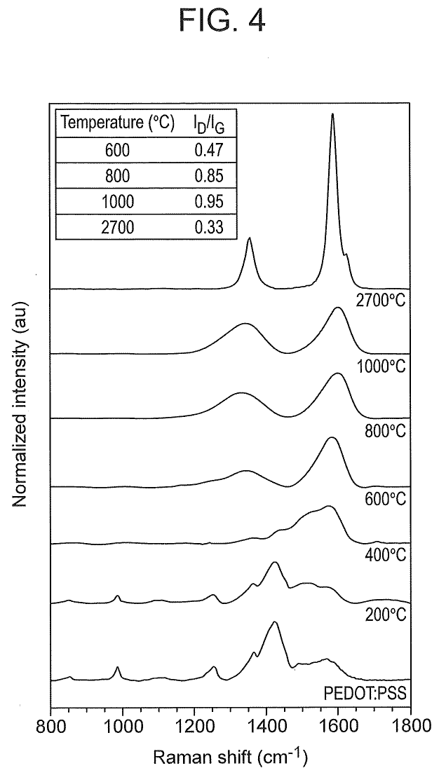

The chemical structure of directly carbonized PEDOT:PSS fibers was evaluated with Raman spectroscopy. FIG. 4 displays the evolution of the PEDOT:PSS Raman spectrum upon increasing final direct carbonization temperature. The Raman spectrum of precursor PEDOT:PSS shows a main band around 1422 cm⁻¹, attributed to the stretching vibration of C_{α}=C_{β} on the PEDOT thiophene ring. After direct carbonization to 400° C., the Raman spectrum significantly differed from the precursor and the intense main PEDOT band was nearly indiscernible. Interestingly, this corresponds with the previously discussed loss of fiber electrical conductivity after carbonization to 400° C. The conjugated C_{α}=C_{β} bonds along the PEDOT chain serve as the conductive pathway for polaron and bipolaron charge carriers in PEDOT:PSS. Therefore, it is believed that the disappearance of the initially intense Raman peak associated with those conjugated bonds directly correlates with the destruction of that conductive pathway, and thus fiber conductivity.

Upon increasing the final direct carbonization temperature to 600° C., Raman D and G bands characteristic of graphitic materials located around 1350 and 1580 cm⁻¹, respectively, were present (FIG. 4). The D band, though its origin has been heavily debated, is generally associated with disorder stemming from sp³-bonded carbon in graphitic materials, whereas the G band is related to the bond stretching of graphitic sp²-bonded carbon. As such, the ratio of the peak intensities of the D and G bands (I_{D}/I_{G}) is commonly used as a metric for the degree of disorder of graphitic materials. For the PEDOT:PSS fibers in this work, I_{D}/I_{G} increased with temperature after direct carbonization between 600 and 1000° C. (FIG. 4), which would usually suggest their degree of disorder also increased. The improvement of tensile and electrical properties in this temperature regime, however, indicates fibers became increasingly graphitic in nature (FIG. 2, 3A). Interestingly, the application of I_{D}/I_{G} as a measure of graphitic disorder has been shown to break down when crystallite size L_{α} is very small (<2 nm). In this small crystallite regime, I/I_{G} is observed to increase with carbonization temperature, reaching a maximum typically between 600 and 1500° C. Therefore, it is believed that the observed I/I_{G} increase here in PEDOT:PSS fibers during direct carbonization between 600 and 1000° C. occurred due to small crystallite sizes and does not indicate a reduction of graphitic order with greater carbonization in this temperature regime. Once crystallites sufficiently enlarge with further carbonization and eventual graphitization, I/I_{G} decreases, indicating the improvement of graphitic order. In this way, upon direct graphitization of PEDOT:PSS fibers to 2700° C., a markedly smaller I/I_{G} value was obtained.

### 2.5. Effect of PEDOT Precursor Concentration

It was initially hypothesized that PSS decomposes and leaves the fiber primarily in the form of SO₂ and benzene early on during carbonization (between 200 and 400° C.). It was therefore believed that PEDOT is the primary component that contributes to the final carbon structure of PEDOT:PSS CFs. Moreover, it was further hypothesized that a higher PEDOT concentration relative to PSS in the precursor fiber would result in a higher CF yield. This was experimentally tested by directly carbonizing PEDOT:PSS fibers possessing various initial concentrations of PEDOT. The concentration of PEDOT in a fiber can be altered by treatments that serve to remove excess PSS. In this work, three types of fiber were tested: coagulation bath fibers, DMSO-drawn fibers, and H₂SO₄-treated fibers. DMSO and H₂SO₄ remove excess PSS in increasing amounts from coagulation bath fibers and thus yield precursor fibers with higher PEDOT concentrations. From their measured linear density, coagulation bath fibers are approximately 28.5 wt % PEDOT relative to PSS, while DMSO-drawn fibers and H₂SO₄-treated fibers possess 35-40 wt % and 60-70 wt % PEDOT, respectively.

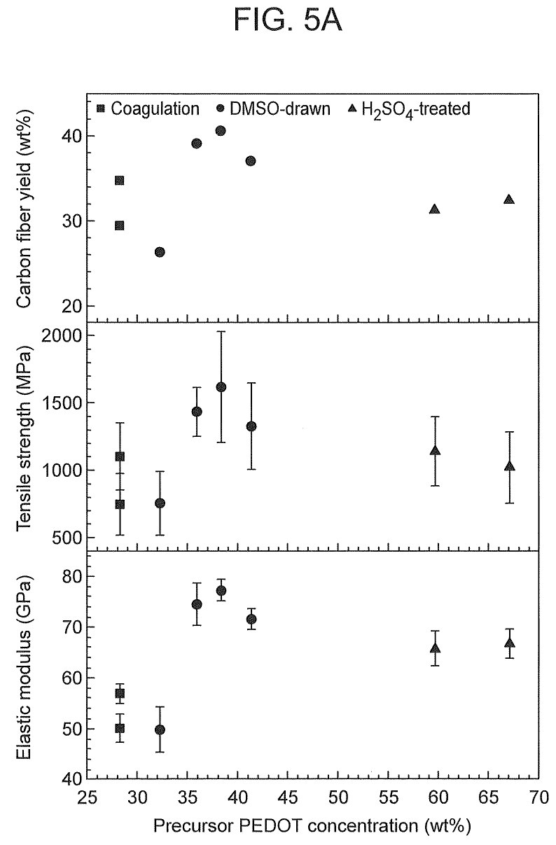

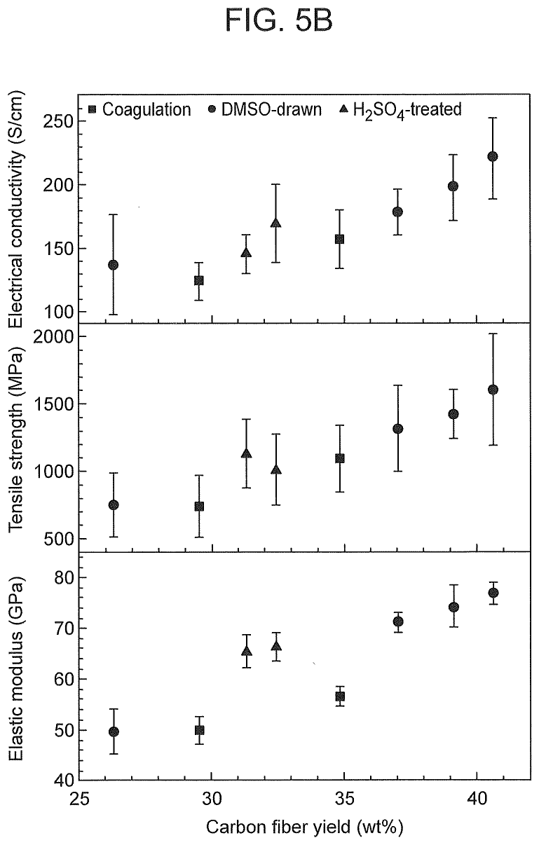

FIG. 5A plots the estimated precursor PEDOT concentration of fibers versus their resultant CF yield. This data shows no straightforward relationship between the concentration of PEDOT in the precursor and the yield achieved after direct carbonization. Likewise, plotting tensile strength and elastic modulus of resultant CFs against their initial PEDOT concentration (FIG. 5A) shows no clear trend. For both CF yield and tensile properties, there is no positive relationship with precursor PEDOT concentration, as was hypothesized. Instead, there appears to be a maximum in resultant CF properties when a precursor contained approximately 40 wt % PEDOT. There is, however, an observable relationship between CF yield and corresponding tensile and electrical properties. FIG. 5B shows CFs with a higher yield also tended to have higher tensile strength, elastic modulus, and electrical conductivity, regardless of their precursor fiber type (coagulation, DMSO-drawn, or H₂SO₄-treated) and associated PEDOT concentration.

### 3. CONCLUSIONS

Compared to traditional carbonization, where a stabilization step is necessary, direct carbonization provides a faster and less energy-intensive means of CF conversion. In this work, CFs were derived from PEDOT.PSS precursor fibers by direct carbonization. Non-fused, void-free, and surface defect-free CFs with a typical yield of 30-40 wt % were obtained, even upon direct graphitization to 2700° C. Resultant CF properties were studied with respect to direct carbonization temperature. Tensile properties significantly improved after carbonization to 800° C., suggesting the beginning of graphitic structure formation. Maximum tensile strength and modulus were achieved at 1000 and 2700° C., respectively. Total loss of electrical conductivity occurred between 200 and 400° C. and is believed to be the result of the destruction of the conjugated backbone of PEDOT. Conductivity returned after direct carbonization to 800° C., indicating the formation of a graphitic structure with free electron charge carriers. This structure was confirmed by Raman spectroscopy demonstrating the development of a D and G band in fibers directly carbonized to 600° C. and higher. Directly graphitized fibers possessed a small I_{G} ratio of 0.33.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a fiber”, as used herein, may also refer to, and encompass, a plurality of fibers.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the method of this disclosure has been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A method of making carbon fibers, comprising:
converting poly (3,4-ethylenedioxythiophene):poly (styrene sulfonate) fibers (PEDOT:PSS fibers) into the carbon fibers by direct carbonization without previously oxidizing the PEDOT:PSS fibers.

2. The method of claim 1, including heating the PEDOT:PSS fibers to a first target temperature of between about 1,0000° C. and about 1,700° C. for a first predetermined period of time sufficient to carbonize the PEDOT:PSS fibers into carbon fibers.

3. The method of claim 2, including completing the heating of the PEDOT:PSS fibers in a flowing inert gas atmosphere.

4. The method of claim 2, including subsequently heating the carbon fibers to a second target temperature of between about 2,000° C. and about 2,800° C. for a second predetermined period of time sufficient to graphitize the carbon fibers.

5. The method of claim 4, including completing the heating of the carbon fibers in a flowing inert gas atmosphere.

6. The method of claim 1, including heating the PEDOT:PSS fibers to a first target temperature of between about 1,100° C. and about 1,400° C. for a first predetermined period of time sufficient to carbonize the PEDOT:PSS fibers into carbon fibers.

7. The method of claim 6, including completing the heating of the PEDOT:PSS fibers in a flowing inert gas atmosphere.

8. The method of claim 6, including subsequently heating the carbon fibers to a second target temperature of between about 2,200° C. and about 2,600° C. for a second predetermined period of time sufficient to graphitize the carbon fibers.

9. The method of claim 8, including completing the heating of the carbon fibers in a flowing inert gas atmosphere.

10. A method of making carbon fibers, consisting of:
converting poly (3,4-ethylenedioxythiophene):poly (styrene sulfonate) fibers (PEDOT:PSS fibers) into the carbon fibers by direct carbonization without previously oxidizing the PEDOT:PSS fibers.

11. The method of claim 10, including heating the PEDOT:PSS fibers to a first target temperature of between about 1,0000° C. and about 1,700° C. for a first predetermined period of time sufficient to carbonize the PEDOT:PSS fibers into carbon fibers.

12. The method of claim 11, including completing the heating of the PEDOT:PSS fibers in a flowing nitrogen atmosphere.

13. The method of claim 11, including subsequently heating the carbon fibers to a second target temperature of between about 2,000° C. and about 2,8000° C. for a second predetermined period of time sufficient to graphitize the carbon fibers.

14. The method of claim 13, including completing the heating of the carbon fibers in a flowing inert gas atmosphere.

15. The method of claim 10, including heating the PEDOT:PSS fibers to a first target temperature of between about 1,100° C. and about 1,400° C. for a first predetermined period of time sufficient to carbonize the PEDOT:PSS fibers into carbon fibers.

16. The method of claim 15, including completing the heating of the PEDOT:PSS fibers in a flowing inert gas atmosphere.

17. The method of claim 15, including subsequently heating the carbon fibers to a second target temperature of between about 2,2000° C. and about 2,6000° C. for a second predetermined period of time sufficient to graphitize the carbon fibers.

18. The method of claim 17, including completing the heating of the carbon fibers in a flowing inert gas atmosphere.
